(19) United States
(12) Patent Application Publication
(10) Pub. No.: US 2007/0026152 A1
(43) Pub. Date: Feb. 1, 2007

(54) Method for creating a pattern on a concrete or asphalt surface.

(76) Inventor: Gerry B. Oliver, Tega Cay, SC (US)

Correspondence Address: Gerry Oliver, Suite 101-222, 1750 Hwy 160 West, Fort Mill, SC, 29708, US

(21) Appl. No.: 11/161,278

(22) Filed: Jul. 28, 2005

(51) Int. Cl. B05D 1/12; B05D 5/00

(52) U.S. Cl. 427/282; 427/180

(57) ABSTRACT

This invention relates to a method of creating a pattern on a concrete or asphalt surface. A stencil is gently adhered to a concrete or asphalt surface and a liquid coating is applied over the stencil covering the entire concrete or asphalt surface. A stone aggregate is broadcast onto the liquid coating absorbing the liquid coating. The stencil is removed prior to the liquid coating substantially setting or curing. The loose excess stone aggregate is then removed from the surface. The surface directly below the stencil is void of stone aggregate and provides the appearance of a brick and a mortar joint.

### BACKGROUND OF THE INVENTION

Various methods have been devised to create a decorative pattern on concrete and asphalt surfaces. Most of these methods require stamping a pattern into the soft concrete or asphalt and then applying a liquid or dry coating to resemble a brick or stone surface. Another method is to apply a stencil and spray or trowel a coating over the stencil, removing the stencil to reveal a brick or stone appearance.

### BRIEF SUMMARY OF THE INVENTION

This invention utilizes a stencil gently adhered to the substrate, a liquid coating spread over the stencil and an aggregate broadcast onto the liquid coating. The stencil is removed prior to the coating substantially setting. The excess aggregate is then removed from the surface.

### BRIEF DESCRIPTION OF THE DRAWINGS

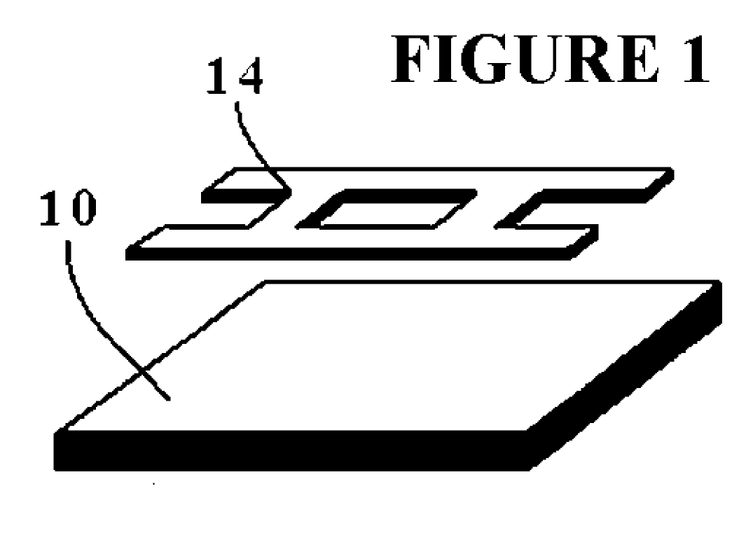

(FIG. 1) A stencil with a predetermined pattern 14 and a concrete or asphalt surface 10.

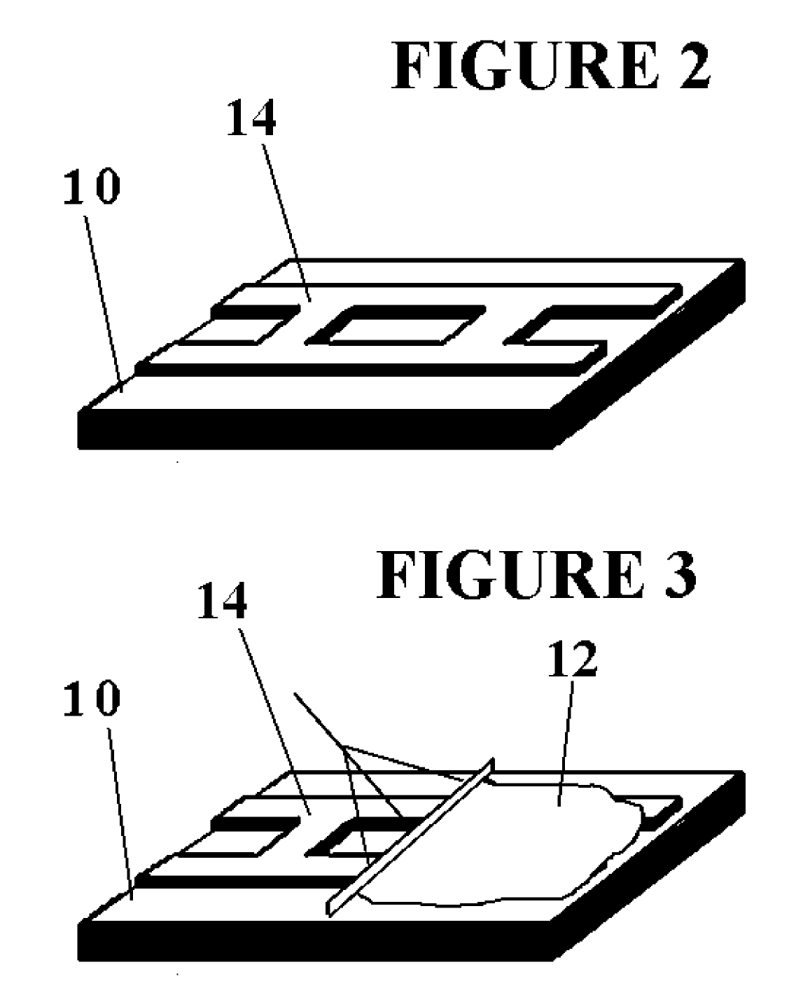

(FIG.2) The stencil with the predetermined pattern 14 is gently adhered to the concrete or asphalt surface 10.

(FIG.3) A liquid coating 12 is applied over the stencil 14 covering the concrete or asphalt surface 10.

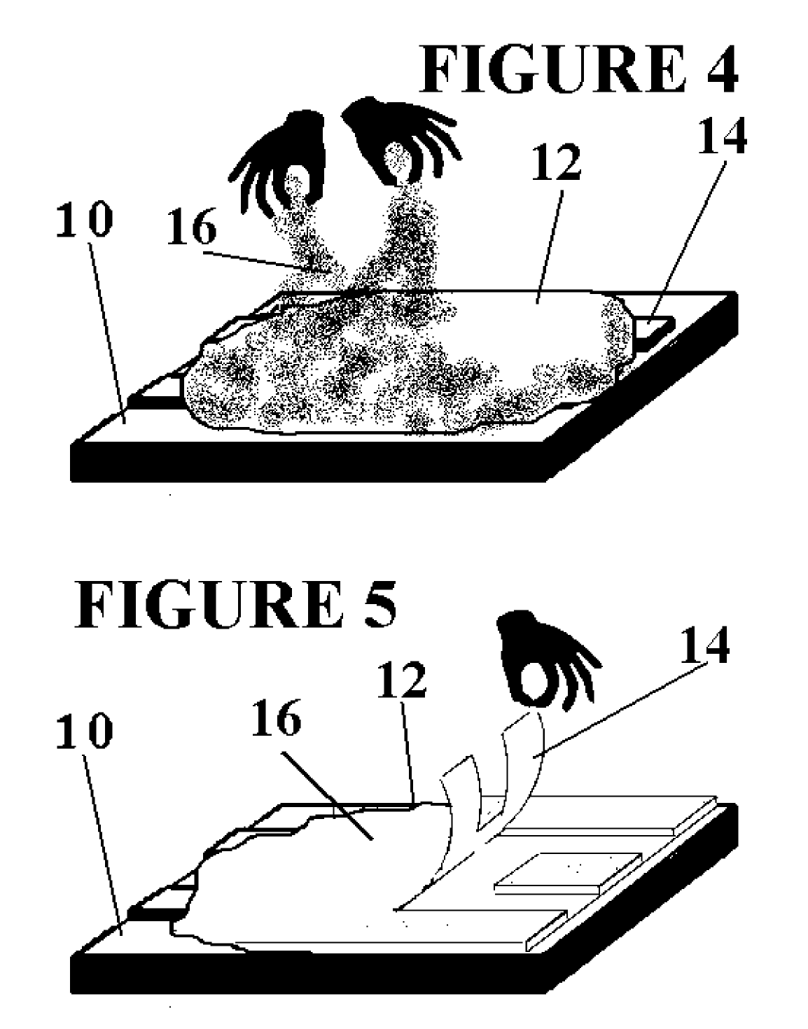

(FIG.4) A stone aggregate 16 is broadcast onto the liquid coating 12.

(FIG.5) The stencil 14 is removed from the concrete or asphalt substrate 10 revealing the substrate 10 below the stencil 14 replicating a brick and mortar appearance.

What is claimed is:

1. A method of creating a pattern on a concrete or asphalt surface by gently adhering a stencil to the substrate; applying a liquid coating over the stencil, broadcasting an aggregate onto the liquid coating, removing the stencil prior to the coating substantially setting, removing the excess loose stone from the surface when the coating has set.

2. A method according to claim 1, wherein the stencil is a predetermined pattern.

3. A method according to claim 2, wherein the stencil is constructed of paper.

4. A method according to claim 2, wherein the stencil is constructed of plastic.

5. A method according to claim 1, wherein the liquid coating is a settable coating.

6. A method according to claim 1, wherein the aggregate is a stone aggregate.
